(19) United States
(12) Patent Application Publication
(10) Pub. No.: US 2024/0281002 A1
(43) Pub. Date: Aug. 22, 2024

(54) Drone Based Life Saving System Using Wireless Technologies

(71) Applicant: Dharmesh Joshi, Plainsboro, NJ (US)

(72) Inventor: Dharmesh Joshi, Plainsboro, NJ (US)

(73) Assignee: Dharmesh Joshi, Plainsboro, NJ (US)

(21) Appl. No.: 18/412,621

(22) Filed: Jan. 15, 2024

Related U.S. Application Data
(60) Provisional application No. 63/369,651, filed on Jul. 27, 2022.

(51) Int. Cl. G05D 1/247; G05D 1/656; G05D 105/55; G05D 109/20; G05D 111/30; H04W 4/90

(52) U.S. Cl. CPC G05D 1/247; G05D 1/656; H04W 4/90; G05D 2105/55; G05D 2109/20; G05D 2111/32

(57) ABSTRACT

Cellular devices such as smartphones, smart watches, tablets, phones that are not smart and any form of devices that use cellular communications can be located using cellular triangulation. Current commercial cellular communication devices provide accurate information within a range of 10 or more meters. Also, sometimes due to improper coverage of an area by a commercial cellular network, the location information would be bad to zero. Also in some emergency situations, cellular towers may be destroyed or malfunction or cannot be used. In case of emergency situations, if emergency personnel use drones enabled with cellular technology from a close range using triangulation, this can provide highly accurate location information of the victims and can also help communicate with the victim and help them out of danger in a safe manner.

### BACKGROUND OF THE INVENTION

1. In case of emergency situations from small scale to large scale ones where saving lives is very time critical and for this purpose it is necessary to locate people who are trapped in the emergency situation in order to rescue them in a very timely manner.
2. The victims trapped in the emergency situation can be rescued with a drone based system presented here where emergency personnel can use a combination of different technologies mounted onto the drones themselves to locate and rescue people trapped in the emergency faster than conventional means.
3. The wireless technology (cellular technology) presented here locates the victim's cellular device using triangulation to a high degree of accuracy which current cellular towers do not provide.

### DETAILED DESCRIPTION OF THE INVENTION

### A. Application of Drone for Use in Emergency Situations Using Wireless Communication.

1. In an event of an emergency, one or more rescue teams are dispatched to the location of the emergency. These teams carry their essential equipment needed for the rescue. With the addition of a collection of specialized drones described below. The number of these emergency drones in a rescue team can range anywhere from as little as 5 to hundred or more depending on the emergency situation and devastation caused by the emergency situation. These emergencies can range from building fires, hostage situations, medical emergencies, earthquakes, tornados, flooding, wildfires, etc. 1. Each emergency drone system consists of drones, a base station with computers, wireless communication equipment and generator(s) with sufficient fuel according to the emergency conditions.
2. When the emergency response team arrives at the emergency location, the operators set up the command center outside or within the affected area as the emergency situation permits. After setting up the command center, dish antennas are set up, generators are started and systems (computers, wireless equipment) are powered up. There can be more than one command center and all the command centers are connected to each other and central command (eg. FEMA HQ or Police HQ or EMS HQ or any other form of HQ that can coordinate communications with all command centers)
3. It is a good idea to let the command centers focus on triangulation and map the terrain with radar or thermal imaging equipment or night vision or lights as appropriate. And actual communication with the individual victims can be done by personnel located at the HQ and they can communicate with roving rescue teams and command centers.
4. There may be drone trays (consisting of arrays of drones ranging from 5 to a larger number of may be 50 or a 100 or more depending upon the emergency situation) are laid out. The drone batteries are already fully charged at the home location (where they are located and stored when they are not required to be used.)
5. When the drone trays are laid out for use in an emergency, they can be powered on either individually or in groups via unique codes (drone identification number—DIN.) They can be launched in an automatic mode where they automatically start their routine (activity) as pre-programmed at the home location or in a factory according to their desired actions for that emergency. Or they can be launched via the base station operators. Or both by manually overriding the default behavior. And then they start their emergency routine.
6. The drones also communicate with each other and also help facilitate communication between command centers and the command centers provide communication with central command.
7. The drones are capable of locating cellular devices at different heights and depths (in rubble for example.) The zero position of the height and depth scale can be determined by the rescue team. Possibly sea level or the ground level or any other scale that they determine based on the devastation.
8. The drones should be capable of picking up weak signals from low battery or location of victims by using highly sensitive antennas.
9. There has to be a mechanism to identify the drones' and rescue team's mobile signature from victims' mobile signature. This can be done by adding the drones' and rescue team members' mobile signatures to the system so rescue members' devices can automatically be identified. This helps in identifying if a rescue team member is near to a victim then the rescue member can be easily asked to attend to the nearby victim.
10. All rescue people should carry a tablet or a laptop along with a headset so that they can be in contact with other rescue members and the rest of the entire rescue team. The communication between rescue team members and command centers is facilitated by drone's cellular capabilities.
11. Drones are connected to GPS satellites and provide their location to command centers and HQ.
12. Detection of the victim's cellular device is done by a specially designed antenna and the drones' antenna search has a spherical detect area so victims can be identified across all shapes of terrain around the drones.
13. Drones should also be capable of detecting each other so they do not crash into one another.

### B. Application in a Large Scale Emergency

1. Drone Activity highly depends on the nature of the situation that they are deployed for. For example, in a large-scale emergency situation such as earthquake, tornadoes, cyclones, volcanic eruptions, flooding, wildfires, etc, there are large-scale devastations and most of the buildings are turned to rubble. Additionally, the geographic area is huge. This can be anywhere from several square miles to a few hundred square miles. In these kinds of situations, we need more equipment that is tougher and can last longer.
2. There may be more than one command center situated partially or completely around the area. These command centers have high capacity generators, more fuel, faster computers, larger wireless communications systems and a satellite connectivity to connect with the central command and HQ that may be far far away (eg. FEMA HQ.)
3. When the drones are powered on, the command centers decide how to distribute the drones across the devastated area or it may be automated. They take help from satellite images if available or they let a set of drones fly out in different patterns such as to form a circular arc where the command center forming another circle with a smaller radius inside the outer circular deployment of drones and again another set of drones in another smaller circle and so on, around and over the devastated area.
4. Another deployment configuration can be to move the drones in sets of 3 to 5 where they move in different heights in circles for faster triangulation and this can also achieve 3D triangulation and also the drones can detect via a spherical shaped range with help of specially designed cellular antenna.
5. Whatever form of drone deployment is used, the goal is to quickly map the terrain using radar, ping as many cell phones (victim's phones) and put them in emergency mode.
6. Radars are also used to navigate the drones in order to avoid other drones or buildings. In case a drone finds that the terrain is changing they adapt to the new height from the terrain and remain a few feet above the terrain for better reception from the victim's cellular devices in case of weak signals from victims' devices.
7. As the drones move out further, they remain in contact with each other by pinging themselves via their wireless communication link and send out the information to their respective command centers so the operators at the command centers get the information about the location of their drones.
8. When the drones are flying onto the devastated area, they begin scanning the surface below via radar, night vision, lights and thermal imaging systems that they have. They also send out this information to the command centers. Radar helps to map the area. Thermal imaging helps to see hot spots (perhaps locate victims)
9. The drones use radar to locate the terrain and also to navigate to avoid hitting other drones or other debris that is higher than drone height or some buildings that are still standing.
10. Since in emergency situations, the cellular towers are not accurate or non-available, the drones are equipped with cellular technology equipment. So they ping all the smart devices/smart devices/smart phones/tablets/smart watches, etc in their vicinity. \
11. When a cell phone/smart device is successfully pinged, the drones with their smart cellular antennae start to triangulate the location of the pinged cellular device and pinpoint its location on the command center grid for the rescue teams to pursue.
12. The grids can be further subdivided into smaller grids for management of the terrain and to have better management and an efficient process of identifying and rescuing victims.
13. The drones immediately put the mobile devices of a victim into emergency mode and the command center operators are notified and nearby rescue teams are notified. The central command and HQ is also notified about this and they can contact the victims via satellite link and drone smart link to the smart device and talk to them and assess the situation of the victim(s). They can then contact rescue teams via command center and provide information on how to prioritize their activity.
14. Initially the drones are sent on a scout mission to map the terrain, look for hot spots and ping the cellular devices. As more and more area is covered and mapped, other sets of drones are sent to help existing drones to cover more area and focus on triangulation.
15. As triangulation is in progress, more drones are sent to act as cellular towers while they hover in the air stationary and simultaneously sending messages across between rescue teams, command centers and central command (HQ). They can also talk to the victims via the satellite link from HQ via drones.
16. Apart from acting as cellular triangulation devices, the drones also help establish a communication link between the rescue personnel and the victims.
17. With the drones flying at different altitudes, they can also change altitudes depending upon the size of the rubble, presence of high structures and help identify the location of a victim's exact position within the rubble or half destructed buildings and this can help reduce teams to reach the victims and help assess the medical condition of the victim with cellular communication based talking with the victim. The drones detect the height of the buildings or rubbles using radars.
18. Drones fly a few feet above the terrain and detect changes in terrain and modify their route. This helps in better Detection of victims.

### C. Application in an Emergency Such as a Building Fire

1. In case of a building fire, there can be 5 or more drones depending on the size (width or height) of the building.
2. The drones start from the bottom and start surrounding the building and they move around the building in a circle (each drone is part of the circle but at some distance between them around their flight circumference) though they may be at different heights.
3. The drones then move in an upward direction and ping the cellphones (victim's.)
4. The HQ personnel contact the victim's and assess their condition such as the injury that they may have or someone close to them is injured or they are in immediate danger (so they can be attended to first.) Other victims may be informed to move to safety or take some other precautions that can get them to safety.
5. Victims may not know where the fire (or other emergency is) but with the help of drones, the emergency personnel know so the victims can be asked to avoid certain areas and move to other safer locations from where they can be evacuated.
6. Sometimes victims may be within the danger zone but not visible to the naked eye. Such victims can easily be located via the drones cellular antenna based triangulation capabilities.

### D. Application in an Emergency Such as Locating a Medical Patient

1. In any kind of emergency situation, large or small or minor, EMS (Emergency Medical Services) play an important role. They are required in any kind of emergency other than fire or a large-scale devastation also. They may be called to find a victim or a patient who is in need of emergency medical attention while sometimes the location of the victim is not known. For example, a victim places a call to 911 and asks for help and she may or may not be able to tell the exact location of herself but her cell phone is activated with 911 emergency response service and drones can locate her exact location.
2. Or perhaps a kid calls 911 for help needed to an injured grown up but the kid may be small or in a condition that she may not be able to give more information.
3. The EMS team uses drones to locate the victim with cellphone details given to the EMS team by the 911 operator and reach her at the earliest. This is a lot faster than physically checking out the whole area.
4. This kind of activity may need around 3 to 5 drones but depends on the decision of the rescue team.

### E. Application in an Emergency Related to Police Activity

1. Police can use drones to identify and locate victims in order to reach them quickly. And also if necessary information about the perpetrator is available then they can use it.
2. Police can also use drones to identify suspects' location within a given area. This activity is currently done by physically scanning the area and sometimes during this, the suspect may have left the area.
3. It is possible that the perpetrators may not be using cellular devices but some sort of walkie talkie devices. In such cases, the drones can also be equipped with microwave reception antennas and can triangulate the walkie talkie signals to help locate the perpetrators and monitor their movements.
4. In case of a hostage situation, police can locate the victims within the suspected area and depending upon the intelligence received from drones, they can make informed decisions about the location of the perpetrators. For example, cellular devices that are closer to the floor and not moving around are more likely to be victims while cellular devices/other microwave devices that move around fast and are few feet above the floor are the perpetrators.

### F. A Typical Construction of a Drone for Use in an Emergency Using Wireless Communication

1. The number of propellers and size depends on the utility of the drone. This depends on small scale rescue operation or large scale operation or mid sized one and should be capable of flying easily across large distances with the equipment onboard. The battery should also have enough power to handle this.
2. A typical rescue drone consists of a motherboard that is powered by a battery.
3. The motherboard is connected to a cellular antenna and its circuit board. The cellular antenna is designed to transmit and receive data from all sides of the drone, including around the drone.
4. The is also a hard drive to store data for later retrieval. This data can also be used to identify issues that occurred during the entire operation of the rescue and how it responded to the situation.
5. The motherboard also has a CPU (Computer Processing Unit) chip and memory (RAM) chips to process the data
6. Motherboard also is connected to the other circuit boards for radar, night vision, thermal imaging, search light(s) etc. and controls them as needed.
7. Radar based detection is present to detect all around the drone to avoid obstacles in the form of buildings or rubble to help identify terrain and also to help navigate.
8. There may or may not be separate batteries for drone navigation and motherboard and other components. This depends on the usage and application of the drone in a given emergency situation.
9. Drones have one or more rotors depending on where and how they are used. Sometimes they may be needed to operate for hours or a day or more. The batteries should have enough power to support the functionality of the drone and return back to base and maintain data that was collected during the functioning.
10. The drone has battery capacity measuring software module that monitors the battery levels and reports the same to the base and command center operators can put in a new drone at the same location as the other drone and when replaced, the drone with lower power can be safely brought back to the base without any loss of communication with the victims or the command HQ or other command centers.
11. Drones have information about other drones and cellular devices of rescue teams so those devices are not flagged.

### G. A Typical Setup for Software Needed to Run the Entire Operation

1. Drones have software and an operating system on the hard disk and running on CPU and RAM. The drones have firmware to operate all the peripherals on it.
2. Software on each drone connects all the peripherals and controls the actions of the drone.
3. One module of the software in each drone operates the triangulation of the cellular devices with coordination of another 2 or more drones since this triangulation is done in 360 degrees around a drone.
4. Another module of the software communicates with the command center providing its precise location along with the triangulated cellular device details and location.
5. Another module of software established a voice or visual connection on screen and headsets with the roving emergency team and the command center and the HQ. This can also be connected to the victim's device as needed for audio or video call with the victim's device.
6. The command center has another set of equipment like antennas to communicate with all drones as needed and generators as needed to power the operation and keep it running.
7. Command center personnel and HQ can map the precise location of the victim and the drones on various computer monitors and a larger screen such as a huge monitor or multiple monitors or a projector projecting on a screen.
8. The computer systems/tablets on command centers, HQ and emergency roving team have the ability to zoom in, zoom out, scroll in any direction of the different grids for better location of the victims and also to locate the next victim to rescue. There can be multiple grids inside one grid for better viewing and management.
9. The command center also has a dish antenna to connect to the HQ directly or via a satellite link. This may depend on the scale of the emergency.
10. The HQ has access to all data from all drones and command centers. They coordinate all efforts with command centers and drones to reach out to each victim and work with the emergency roving team to help the victims.
11. The emergency roving teams have a tablet or a small computer with access to the command center. The HQ/command centers provide the emergency roving teams with location of a grid and precise location of the victims inside the rubble or the danger zone so the victims can be evacuated faster.
12. There will be a point where all the drones across all command centers have mapped the terrain and have identified all possible cellular devices. From that point, the drones simply assist in communication from HQ to command centers or HQ to victims or command centers to victims as desired. But they will also monitor for new cellular devices that come online at a later stage and the newly identified cellular devices are also added to the system.

### The Big Picture

1. One Drone is equipped with Propellers (Legend Numbered 1), a common unit attachment housing Radar, night vision camera, thermal imaging camera, a normal camera, search light (Legend Numbered 2) and cellular antenna (Legend Numbered 3). Drone connects to other cellular devices and rescue teams (Legend Numbered 4) with cellular connectivity link (Legend Numbered 5). Please note that the drone design in the image is just for illustration purposes. The actual drones will differ greatly depending on the use, type of emergency, need to deploy quickly among other factors.
2. Three drones (Legend Numbered 6) mapping terrain, running camera/night vision, thermal imaging, communicating (Legend Numbered 7) and triangulation of mobile devices possessed by victims (Legend Numbered 8). Data sent out by drones to the command team(s) and roving team(s) where it is fed to a computer software to assess the situation in real time.
3. Victims (Legend Numbered 9) are triangulated (Legend Numbered 10) by multiple drones (Legend Numbered 11). These drones communicate (Legend Numbered 12) with Command Centers (Legend Numbered 13) mapping the location within a grid within a set of computers (Legend Numbered 14) and communicating (Legend Numbered 15) with roving rescue teams (Legend Numbered 16) and send live data and feed (Legend Numbered 17) with a satellite (Legend Numbered 18) with communication link (Legend Numbered 19) to the HQ (Legend Numbered 201) for large scale devastation rescue operations. Roving rescue teams (Legend Numbered 16) get data (Legend Numbered 15) from Command Centers (Legend Numbered 13) look for victims (Legend Numbered 9) with specific location details and possible knowledge of their surroundings, physical and emotional conditions (Legend Numbered 21).
4. Victims are arranged in a grid with location and height/depth of a victim in the affected area. The grid appears on all rescue personal tablets or screens and the images/grids can be scrolled in any direction and zoomed in or out or zoomed inside the grid. The number next to the victim indicates the height or depth of the victim. There can be more information captured and displayed such as the victim's name, medical needs, cellular number or any other information that is relevant in the given situation. Victims with larger icons (Legend Numbered 22) have stronger cellular signal strengths while victims with smaller icons (Legend Numbered 23) have lower cellular signal strengths. The weaker signal strengths can be due to a low battery or being physically deeper in the rubble. A deep and stronger triangulation mechanism such as one with smarter triangulation algorithms and/or drones equipped with more powerful cellular antennas can be used to identify this. Original drawing replaced with a new drawing.

### DRAWINGS DESCRIPTION

FIG. 1: One Drone equipped with Radar, camera, night vision camera, thermal imaging camera, a normal camera and cellular antenna. Please note that the drone design in the image is just for illustration purposes.

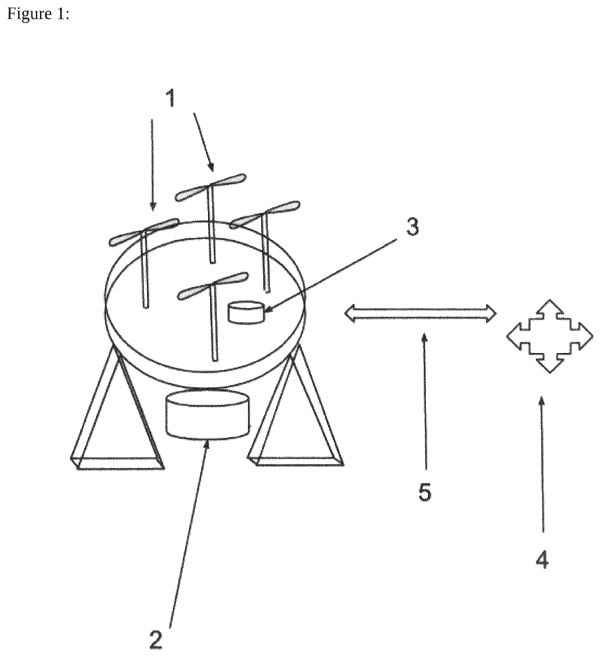

FIG. 2: Three drones mapping terrain, running camera/night vision, thermal imaging, communicating and triangulation of mobile devices possessed by victims.

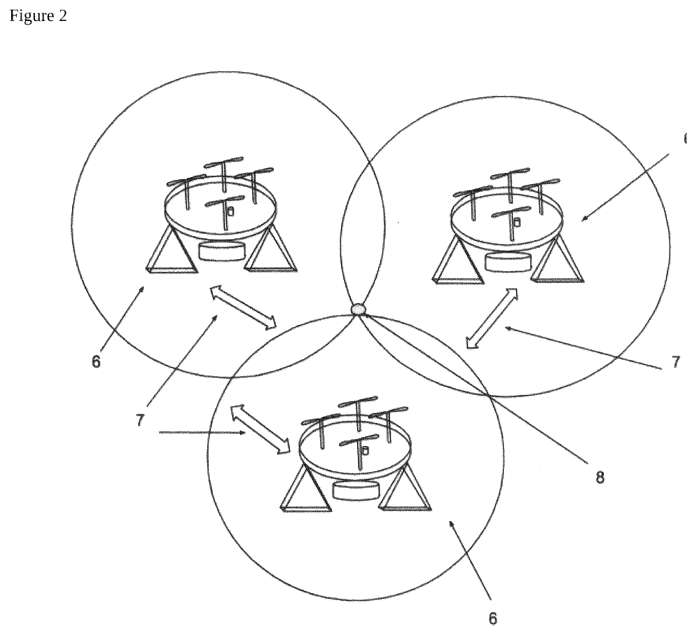

FIG. 5: Showing victims being triangulated. Command centers mapping the location within a grid and communicating with roving rescue teams and HQ for large scale devastation rescue operations.

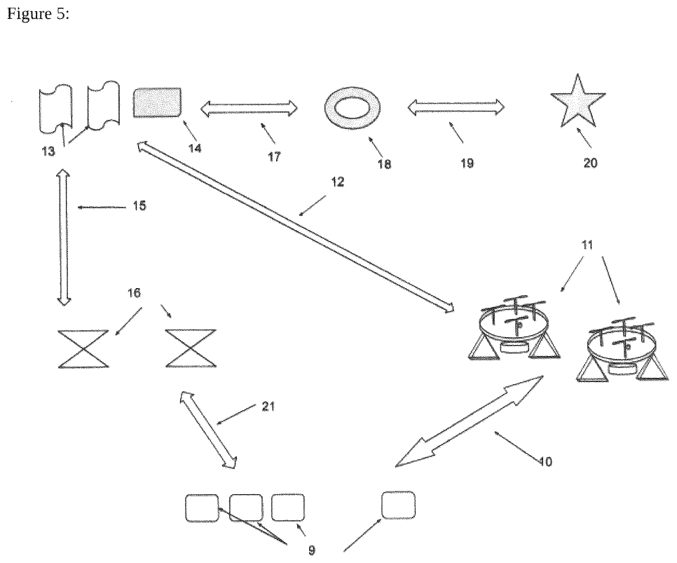

FIG. 6: Showing victims in an example grid with location and height/depth of a victim in the affected area.

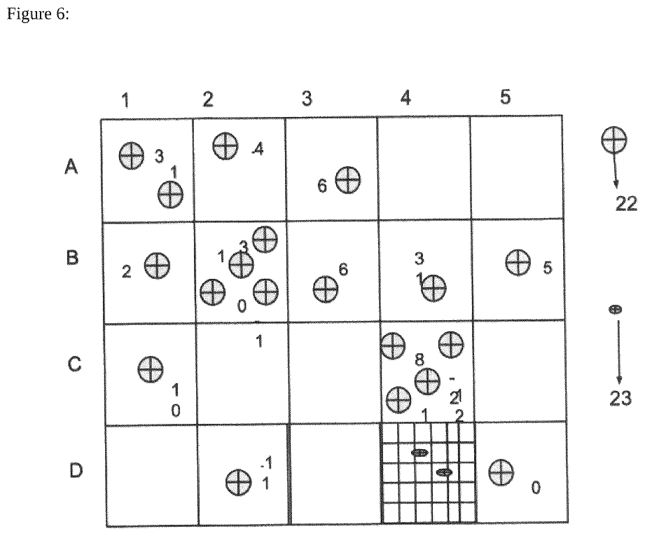

1. In an emergency situation, a drone based life saving system uses a combination of technologies used with drones for more precise locating of victims trapped.

2. Drones equipped with multiple devices such as radar, cellular technology antenna, thermal imaging device, camera and night vision.

3. Drones with their capability of flying at different altitudes and close to the target area provide precise location information using cellular technology and this precision is not currently available in the real and normal world with cellular technology.

4. Drones can communicate with each other, roving teams, command center(s) operated by emergency personnel, as well as HQ and also collect information from drones in real time and guide roving teams of emergency personnel to locate victims.

5. The emergency personnel can also communicate with the victims who may be in different medical conditions and help them on a priority basis using this system.
